(19) United States
(12) Patent Application Publication
(10) Pub. No.: US 2026/0252281 A1
(43) Pub. Date: Aug. 27, 2026

(54) STORAGE MEDIUM, METHOD FOR CONTROLLING INFORMATION PROCESSING APPARATUS, AND INFORMATION PROCESSING APPARATUS

(71) Applicant: CANON KABUSHIKI KAISHA, Tokyo (JP)

(72) Inventor: MOMOKA USHIYAMA, Kanagawa (JP)

(21) Appl. No.: 19/537,718

(22) Filed: Feb. 12, 2026

(30) Foreign Application Priority Data
Feb. 26, 2025 (JP) 2025-029302

(51) Int. Cl. G06F 3/12

(52) U.S. Cl. CPC G06F 3/1204; G06F 3/1285; G06F 3/1292

(57) ABSTRACT

A non-transitory computer-readable storage medium storing one or more programs configured to cause one or more computers of an information processing apparatus capable of communicating with an external processing apparatus. The computers function as: a reception unit configured to receive an instruction to perform specific processing to a first processing apparatus; a specifying unit configured to specify a processing apparatus which has a name containing a specific character string and is capable of communication in a first case where the instruction is received by the reception unit and communication is impossible with the first processing apparatus; and a display control unit configured to perform, in the first case, control for displaying first information indicating a second processing apparatus which is different from the first processing apparatus and is specified by the specifying unit.

### BACKGROUND

### Field of the Technology

The present disclosure relates to a storage medium, a method for controlling an information processing apparatus, and an information processing apparatus.

### Description of the Related Art

A technique in which in a case where specific processing is executed from an information processing apparatus to an external processing apparatus, a notification of information such as the state of the external processing apparatus is made is known.

Japanese Patent Laid-Open No. 2023-088110 discloses a technique in which in a situation where an operation of powering off a printer connected to a computer has been performed in order to cancel an error having occurred in the printer, an appropriate notification is made in a case where an instruction for executing specific processing is given from the computer.

What is demanded is an improvement in usability in an information processing apparatus to which an external processing apparatus is connected.

### SUMMARY

A storage medium according to one aspect of the present disclosure is a non-transitory computer-readable storage medium storing one or more programs configured to cause one or more computers of an information processing apparatus capable of communicating with an external processing apparatus to function as: a reception unit configured to receive an instruction to perform specific processing to a first processing apparatus; a specifying unit configured to specify a processing apparatus which has a name containing a specific character string and is capable of communication in a first case where the instruction is received by the reception unit and communication is impossible with the first processing apparatus; and a display control unit configured to perform, in the first case, control for displaying first information indicating a second processing apparatus which is different from the first processing apparatus and is specified by the specifying unit.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram showing an example of a configuration of a communication system including an information processing apparatus and an external processing apparatus;

FIG. 2 is a block diagram showing an example of configurations of software;

FIG. 3 is a configuration diagram showing an example of a state where a PC and printers are set up;

FIG. 4 is a table showing an example of information which can be obtained from OS-registered printer information;

FIG. 5 is a flowchart showing execution processing of printing;

FIG. 6 is a flowchart showing a detail of job transmission processing;

FIG. 7A and FIG. 7B are diagrams showing examples of printer communication impossibility notification screens;

FIG. 8 is a flowchart showing a detail of online printer list creation processing;

FIG. 9 is a flowchart showing a detail of job transmission processing;

FIG. 10 is a diagram showing an example of a printer communication impossibility notification screen;

FIG. 11 is a flowchart showing second printer selection-time processing;

FIG. 12 is a diagram showing an example of a printer communication impossibility notification screen; and

FIG. 13 is a flowchart showing second printer selection-time processing.

### DESCRIPTION OF THE EMBODIMENTS

Hereinafter, preferred embodiments of the present disclosure will be described in detail with reference to the attached drawings. Note that the following embodiments are not intended to limit the matters of the present disclosure, and all the combinations of features described in the following embodiments are not necessarily essential for the solution of the present disclosure. In addition, the same constituent elements are denoted by the same reference signs.

### First Embodiment

### Overview

An overview of a first embodiment will be described. A technique which displays the state of an external processing apparatus in a case where specific processing is executed from an information processing apparatus to the external processing apparatus is known. For example, there is a technique using a printer driver installed in a host computer as software for controlling a printing apparatus such as an inkjet printer. In a case where execution of processing such as printing is instructed from a host computer which is an information processing apparatus to a printing apparatus which is an external processing apparatus, a message screen indicating the state of the printing apparatus is displayed. In this message screen, in a case where communication is impossible with the printing apparatus, a message reporting a communication impossibility state is displayed to notify the user that since communication is impossible with the printing apparatus of the processing execution destination, the processing cannot be executed.

However, in such a case, there is a problem that even if there is actually another processing apparatus with which communication is possible, the user cannot find this.

As described above, there is room for improving usability in an operation of an information processing apparatus to which an external processing apparatus is connected. In embodiments described below, examples of an information processing apparatus which can appropriately notify a user of the presence of another processing apparatus with which communication is possible in a case where specific processing is executed to a processing apparatus in a communication impossibility state.

### System Configuration

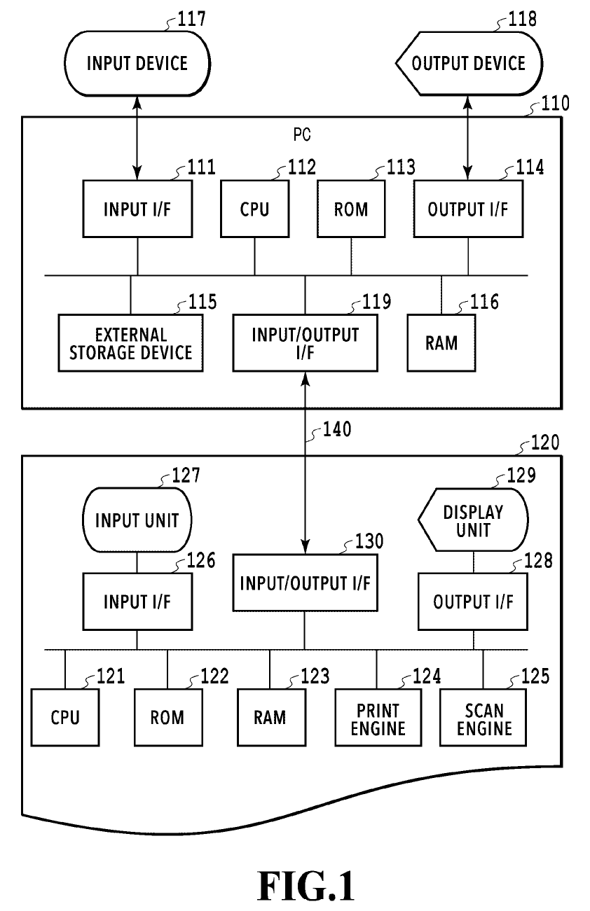

FIG. 1 is a block diagram showing an example of a configuration of a communication system including an information processing apparatus and an external processing apparatus in the present embodiment. Note that although the present embodiment will be described with the following configuration as an example, the present embodiment can be applied to an information processing apparatus which is capable of communicating with an external processing apparatus, and is not intended to limit the configuration and functions as in the drawings.

In the present embodiment, as the information processing apparatus, a personal computer (hereinafter, referred to as a PC) 110 is illustrated. As the information processing apparatus, not only a PC but also various apparatuses such as an image processing apparatus, a mobile terminal, a smartphone, a laptop PC, and a tablet terminal can be applied.

In addition, as the external processing apparatus which is connected with the information processing apparatus in the present embodiment, a printer 120 of inkjet system which is capable of communicating with the information processing apparatus is illustrated. As the external processing apparatus, besides, an image processing apparatus, a PC, a mobile terminal, a smartphone, a tablet terminal, and the like other than the printer of inkjet system can be used. In addition, the image processing apparatus other than the printer of inkjet system includes, for example, apparatuses such as a full color laser beam printer, a monochrome printer, a scanner, a copier, and a facsimile apparatus. Moreover, these apparatuses may be multi-function or single-function.

In addition, the PC 110, which is the information processing apparatus in the present embodiment, causes the printer 120, which is the external processing apparatus, to execute specific processing in accordance with an instruction from a CPU 112 of the PC 110. In the present embodiment, as the specific processing, printing is illustrated, but the specific processing may be execution of scanning or various utility functions of an external processing apparatus besides printing depending on the external processing apparatus to be connected.

The PC 110 includes an input I/F 111, a CPU 112, a ROM 113, an output I/F 114, an external storage device 115, a RAM 116, an input device 117, an output device 118, and an input/output I/F 119.

The CPU 112 is a system control unit, and controls the entire PC 110. The ROM 113 stores a control program to be executed by the CPU 112, and fixed data such as data tables. The external storage device 115 stores an operating system (hereinafter, referred to as an OS), a printer driver, and also various pieces of data and software. Note that in the present embodiment, Windows (registered trademark) is used as the OS as an example.

The RAM 116 is configured with an SRAM (Static Random Access Memory) or the like which requires a backup power supply. Note that since the RAM 116 holds data by using a primary battery for data backup, which is not shown, the RAM 116 can store important data such as program control variables without losing the data. In addition, a memory area which stores setting information, management data, and the like for the PC 110 is also provided in the RAM 116. In addition, the RAM 116 is used as a work memory by various programs stored in the ROM 113 and the external storage device 115.

The input device 117 corresponds to an operation unit which receives operations from the user, and configured with keys such as a numerical value input key, a mode setting key, an enter key, a cancel key, and a power key. The input device 117 is connected to the input I/F 111. The input I/F 111 is an interface for receiving data inputs and operation instructions from the user via the input device 117.

The output device 118 corresponds to a display unit which displays data and the state of the PC 110, and is configured with LEDs (light-emitting diodes), an LCD (liquid-crystal display), and the like. The output device 118 is connected to the output I/F 114. The output I/F 114 is an interface which performs control for the output device 118 to display data and make a notification of the state of the PC 110. Note that the input device 117 and the output device 118 may be configured with the same configuration by performing the display of information and the reception of operations with the same member.

The input/output I/F 119 is connected to an input/output I/F 130 of the printer 120 via a connection interface 140. The connection between the input/output I/F 119 and the input/output I/F 130 makes it possible for the PC 110 and the printer 120 to communicate with each other. The input/output I/F 119 corresponds to a port in the present embodiment. The port is used such that the ports are connected to each other via the connection interface 140 to make it possible for the apparatuses including the ports to communicate with each other. The types of ports include, for example, a network port for performing connection via a network and a USB port for performing connection with a printer using an USB (Universal Serial Bus). Note that in connection via a network, network ports may be directly connected via wireless connection, or may be connected via an access point installed on a wired network. In addition, the connection via a network is performed by using, for example, a wired LAN or a Wireless LAN. In addition, a communication system for the connection includes, for example, Wi-Fi (Wireless Fidelity) (registered trademark) and Bluetooth (registered trademark). Moreover, the communication system includes NFC (Near Field Communication; ISO/IEC IS 18092) and the like. Note that the network port may be prepared individually in accordance with each communication system and connection method. In the present embodiment, the PC 110 is connected to the printer 120 via Port 1. Note that not one PC 110 but a plurality of PCs 110 may be connected to the printer 120.

The connection interface 140 is, for example, USB, LAN, or the like, but is not limited to these. Note that the communication may be directly performed via wireless communication, or may be performed via an access point installed on a wired network. The communication system includes, for example, Wi-Fi (registered trademark), Bluetooth (registered trademark), NFC, and the like.

The printer 120 is an external apparatus in the present embodiment. The printer 120 includes a CPU 121, a ROM 122, a RAM 123, a print engine 124, a scan engine 125, an input I/F 126, an input unit 127, an output I/F 128, a display unit 129, and an input/output I/F 130.

The CPU 121 is a system control unit, and controls the entire printer 120. The ROM 122 stores a control program to be executed by the CPU 121, and fixed data such as data tables.

The RAM 123 is configured with an SRAM or the like which requires a backup power supply. Note that since the RAM 123 holds data by using a primary battery for data backup, which is not shown, the RAM 123 can store important data such as program control variables without losing the data. In addition, the RAM 123 is used as a work memory for the CPU 121, and also used as a buffer for temporarily storing received data. The print engine 124 forms an image on a printing medium such as paper by using a printing material such as an ink based on data stored in the RAM 123 and a print job received from the PC 110, and outputs a result of the printing. The scan engine 125 performs scan based on data stored in the RAM 123.

The input/output I/F 130 is connected to the input/output I/F 119 via the connection interface 140. The input I/F 126 receives an input of the user via the input unit 127, and outputs a result of internal processing to the display unit 129 via the output I/F 128 to notify the user. Note that the input unit 127 and the display unit 129 may be configured with the same configuration. For example, a panel which receives an input of the user and displays a result of internal processing can be configured.

### Software Configuration

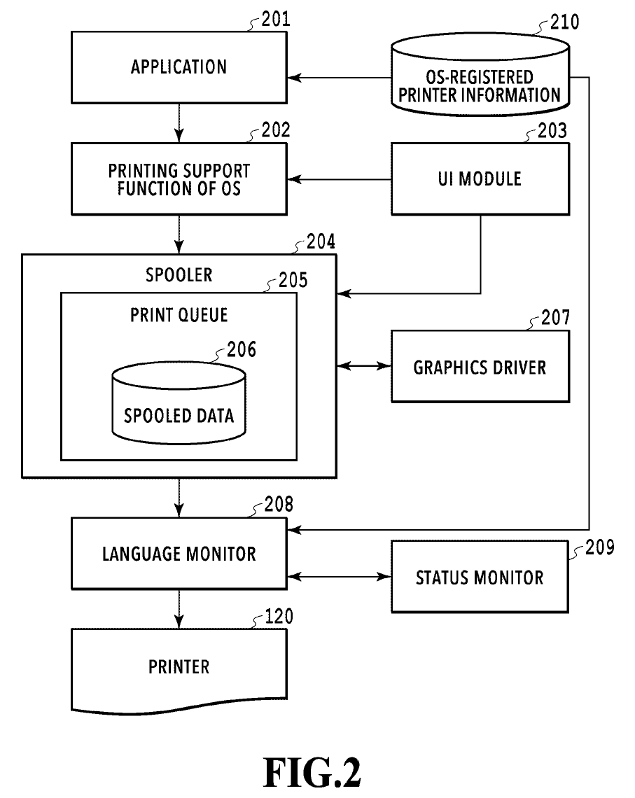

FIG. 2 is a block diagram showing an example of configurations of software according to the present embodiment. In the present embodiment, among the configurations shown in FIG. 2, a printing support function 202 of the OS, a spooler 204, a print queue 205, spooled data 206, and OS-registered printer information 210 are modules of the OS. In addition, a UI (User Interface) module 203, a graphics driver 207, a language monitor 208, and a status monitor 209 are modules of a printer driver. Note that each configuration may be a module of any of the OS and the printer driver. Processing to be executed by each configuration is implemented by the CPU 112 reading out a program corresponding to the configuration from the external storage device 115, loading the program onto the RAM 116, and executing the program.

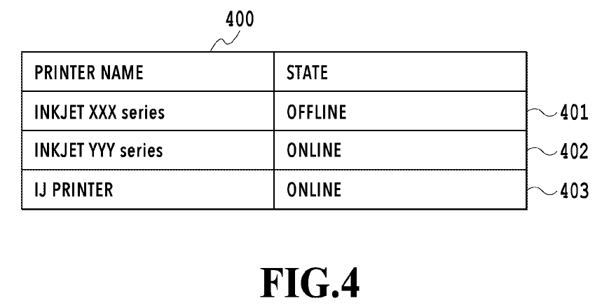

An application 201 is stored in the external storage device 115, and is loaded onto the RAM and executed by the CPU 112. In the case of executing printing, the application 201 obtains OS-registered printer information 210 for determining a printer to execute the printing. In the OS-registered printer information 210, information such as printer names of printers registered in advance as candidates for a processing execution target and the states of the respective printers obtained by the OS is stored (a specific example will be described later by using FIG. 4). After a printer of the print execution target is determined by an input of the user, or the like, the application 201 creates print data which contains image data information containing image information or character information to be printed, print setting information such as a media, a sheet size, and a layout, and the like. The print data contains information indicating the printer of the print execution target.

To the print data created by the application 201, print setting information which is returned from a UI module 203 via the printing support function 202 of the OS is added, and then the print data is temporarily stored in the print queue 205 of the spooler 204 as the spooled data 206.

The spooler 204 has a job management function, and holds and manages spooled data 206 handed to the spooler 204 until it is recognized that transmission of a print job corresponding to the spooled data 206 is completed. Specifically, the spooler 204 manages, for example, a size, job name, and the like of a print job for each printer, and transmits the managed information to a status display application to thus display the information on the output device 118 or the like. Note that information of the spooled data 206 stored in the print queue 205 can be referred to by using a predetermined interface function via the graphics driver 207, the UI module 203, the application 201, and the like, for example. The spooled data 206 is converted by the graphics driver 207 to a printing command which the printer 120 can interpret, so that a print job is generated. The print job thus generated is transmitted from the spooler 204 to the language monitor 208, and the language monitor 208 receives the print job. The print job contains information indicating a printer of print execution target.

The language monitor 208 divides a received print job into packets having a specific size, and successively transmits the packets to the printer 120 via the input/output I/F 119 and the input/output I/F 130. In this event, the size of data to be transmitted each time is instructed by the spooler 204. Note that the spooler 204 executes this instruction by being instructed by the application 201 and the UI module 203. In addition, as a function of the language monitor 208, there is a function of obtaining information on the printer 120 or information on the state of a job inputted into the printer 120. Here, the job is a print job and a scan job, as well as a utility function execution job such as a maintenance job, and the like, for example. In this way, the CPU 112 of the PC 110 causes the printer 120 to execute processing of printing and scanning, as well as a utility function such as maintenance corresponding to a job by transmitting the job to the printer 120.

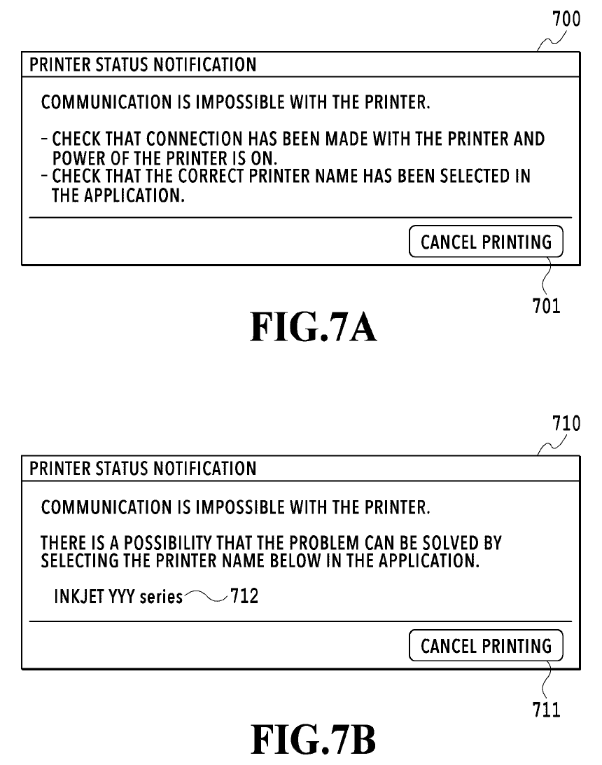

The status monitor 209 performs control for displaying notification in accordance with the information on the printer 120 or the information on the state of the job inputted into the printer 120, which is obtained by the language monitor 208. For example, in a case where the language monitor 208 has obtained information indicating that the printer 120 is in a state where communication is impossible, the status monitor 209 received this information performs control for displaying a notification screen indicating that communication is impossible with the printer 120. The notification screen is displayed on the output device 118 via the output I/F 114. As an example of the notification screen, there is a screen to makes a notification of the state of the printer as shown in a notification screen 700 of FIG. 7A (the detail of FIG. 7A will be described later). In addition, in a case where an input has been made onto a screen displayed by the status monitor 209, the language monitor 208 performs processing corresponding to this input. The language monitor 208 and the status monitor 209 exchange information at the right time as necessary so as to be capable of performing such cooperation processing.

### Overall Configuration

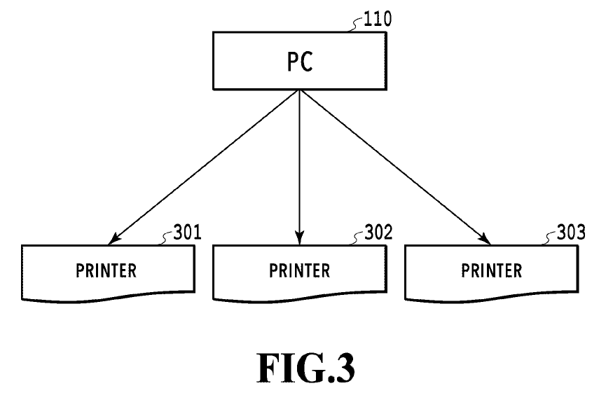

FIG. 3 is a configuration diagram showing an example of a state where a PC and a plurality of printers are set up. In this example, printers 301 to 303 are set up to the PC 110. The state where a printer has been set up indicates that the printer has been connected to the PC 110 once or more, and has been registered in the OS on the PC 110 as a printer to be an execution target of job processing such as printing. Information on a printer which has been set up is stored in the aforementioned OS-registered printer information 210. Internal configurations of the printers 301 to 303 are the same as the configuration of the printer 120 described in FIG. 1.

Note that the overall configuration of the present embodiment is not limited to FIG. 3, and a plurality of PCs 110 may be connected to the printers 301 to 303, or four or more printers may be connected.

### OS-registered Printer Information

FIG. 4 shows an example of information which can be obtained from the OS-registered printer information 210 in the PC 110 in the overall configuration as shown in FIG. 3. Rows 401 to 403 of a Table 400 relating to the OS-registered printer information represent printer names and states of the printers 301 to 303, respectively. In the printer name, for example, at least one character string of a model name, a series name, and a model number can be included.

In addition, the state in FIG. 4 shows information on whether the corresponding printer is in online state or offline state. Note that in a case where the state is online, it indicates the state where the OS has determined that communication is possible with the corresponding printer. On the other hand, in a case where the state is offline, it indicates the state where the OS has determined that communication is impossible with the corresponding printer.

### Processing Flow of First Embodiment

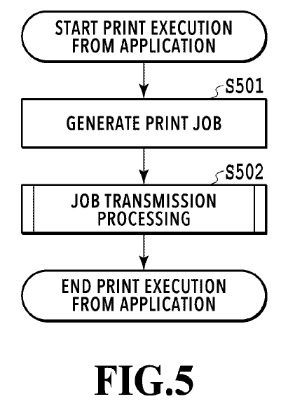

FIG. 5 is a flowchart showing processing in a case where the application 201 makes print execution to the printer 301. The processing of the flowchart shown in FIG. 5 is implemented by the CPU 112 of the PC 110 reading out a program stored in the external storage device 115 or the like onto the RAM 116, and the CPU 112 executing the program. Note that functions of part or all of steps in FIG. 5 may be implemented by hardware such as ASIC, an electronic circuit, or the like. The mark "S" in the description of each processing means a step in the flowchart (hereinafter, the same applies in flowcharts in the present Specification). The processing shown in FIG. 5 is processing executed by the CPU 112 as described above. That is, the processing is implemented by the CPU 112 functioning as each of the printing support function 202, the UI module 203, the spooler 204, the graphics driver 207, the language monitor 208, and the status monitor 209 of the OS. For example, the flowchart of FIG. 5 is for explaining processing and the like of the CPU 112 as the language monitor 208 and the status monitor 209. However, to avoid redundancy of description, hereinafter, the description will be made with the functional configurations shown in FIG. 2 simply as processing subjects.

The processing of the flowchart of FIG. 5 is started by an event that the printing support function 202 of the OS and the printer driver has detected the creation of print data associated with the print execution of the application 201.

First, in S501, the printing support function 202 and the spooler 204 of the OS generate a print job based on print data. The generation of a print job is executed by a series of processing by the respective configurations of the printing support function 202, the UI module 203, the spooler 204, and the graphics driver 207 of the OS in FIG. 2 as mentioned above. As mentioned above, the print job contains information indicating a printer of the print execution target to process the job. The print job generated in S501 is transmitted to the language monitor 208, and the language monitor 208 receives the print job.

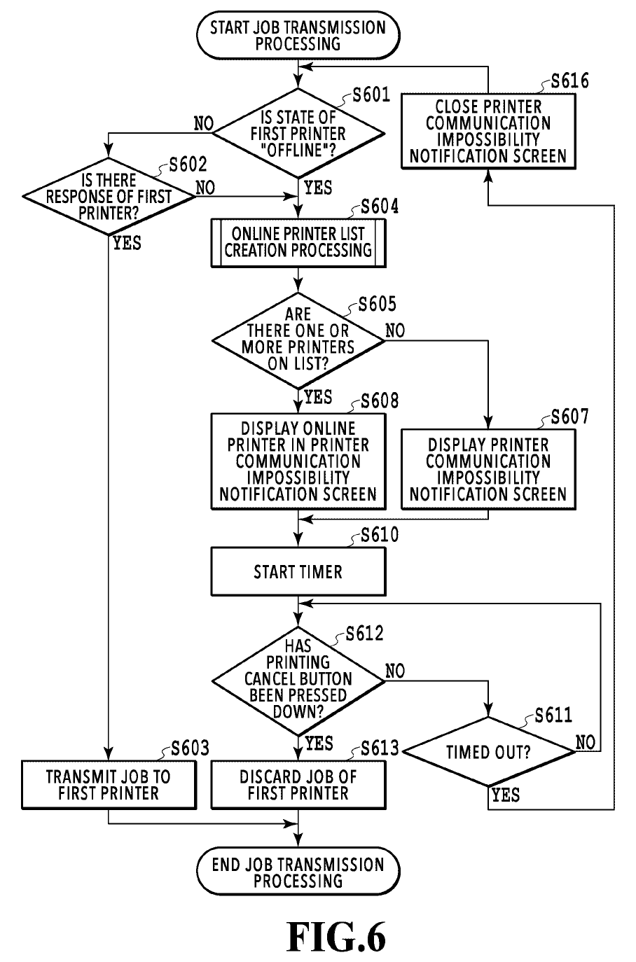

Next, in S502, upon the generation of the print job in S501, the language monitor 208 and the status monitor 209 execute job transmission processing. The detail of the processing in S502 will be described in detail in the description of FIG. 6.

Thereafter, the printing support function 202 of the OS and the printer driver end the processing of the present flowchart.

FIG. 6 is a flowchart showing the detail of the job transmission processing of S502. The processing of the present flowchart is started by an event that the language monitor 208 has detected the print job generated in S501.

First, in S601, the language monitor 208 obtains OS-registered printer information 210, and determines whether the state of a first printer is offline. Note that the first printer is a printer to be subjected to the print execution processing in FIG. 5, and in the present embodiment, is assumed to be the printer 301 in FIG. 3, for example. If the language monitor 208 has determined that the first printer is not offline in S601, the language monitor 208 proceeds to S602. If the language monitor 208 has determined that the first printer is offline, the language monitor 208 proceeds to S604.

In S602, the language monitor 208 communicates directly with the first printer for state inquiry, and determines whether a response that it is possible to execute the job is obtained. This is processing of checking whether communication is possible by directly inquiring about the state because there is a case where a job cannot be received depending on the state of the printer such as during the execution of other processing even if it has been determined on the OS that the printer is in online state and communication is possible. If the language monitor 208 has correctly obtained a response in S602, the language monitor 208 proceeds to S603. In S603, the language monitor 208 transmits the job to the first printer. Then, the language monitor 208 ends the transmission processing of the print job shown in the flowchart of FIG. 6.

On the other hand, in S601, if the language monitor 208 has determined that the first printer is offline, or in S602, if the language monitor 208 has determined that there is no response from the first printer, the language monitor 208 proceeds to S604 and subsequent processing. The processing of S604 to S612 is executed by the status monitor 209.

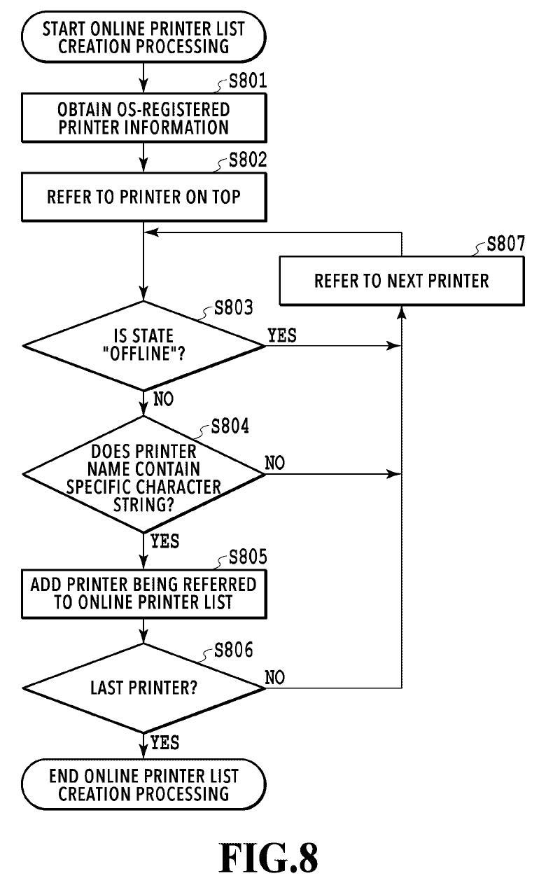

In S604, the status monitor 209 performs processing of creating an online printer list which is a list of a printer which can possibly execute the processing as a substitute for the first printer with which communication is impossible. The detail of the online printer list creation processing of S604 will be describe later in FIG. 8.

Next, in S605, the status monitor 209 determines whether there are one or more printers on the online printer list. If the status monitor 209 has determined that there are not one or more printers in the present step, the status monitor 209 proceeds to S607, and if the status monitor 209 has determined that there are one or more printers, the status monitor 209 proceeds to S608.

In S607, the status monitor 209 controls the output device 118 via the output I/F 114 to display a printer communication impossibility notification screen for making a notification that communication is impossible with the first printer.

FIG. 7A is an example of the printer communication impossibility notification screen to be displayed in S607. The notification screen 700 displays a message indicating that communication has been impossible with the first printer of the processing execution destination. In this event, messages for checking the connection with the first printer, whether the power of the first printer is on, whether a correct printer name has been selected in the application, and the like are also displayed. Note that since there is no other online printer, information relating to a second printer is not displayed. Note that the second printer is a printer that is registered in the OS-registered printer information 210 but is not to be subjected to the print execution processing in FIG. 5.

In this way, in a situation where the PC 110 cannot communicate with the first printer and also cannot communicate with the second printer, the status monitor 209 performs display control for displaying, on the notification screen, information which does not contain information relating to the second printer and which indicates that communication is impossible with the first printer.

The description is returned to the flowchart of FIG. 6. If the status monitor 209 has determined that there are one or more printers on the online printer list in the determination processing of S605, the status monitor 209 proceeds to S608. In S608, the status monitor 209 controls the output device 118 via the output I/F 114 to display a printer communication impossibility notification screen, including the display of information specifying an online printer.

FIG. 7B is an example of the printer communication impossibility notification screen to be displayed in S608. The notification screen 710 displays a notification indicating that communication has been impossible with the printer of the processing execution destination like in the notification screen 700, and also information 712 (a printer name registered in the OS) specifying an online printer with which there is a high possibility that the processing can be executed. That is, information indicating that there is a possibility that the second printer in online state can execute the print job is also displayed. Note that although the notification screen 710 displays information on only one online printer, in a case where there are plurality of printers on the online printer list, information on all the printers may be displayed, or information on only printers with high priority may be displayed.

In this way, in the present embodiment, in a situation where communication is impossible with a first printer but communication is possible with a second printer which is different from the first printer, the status monitor 209 performs display control for displaying information specifying the second printer.

The description is returned to the flowchart of FIG. 6 again. After the status monitor 209 has displayed the printer communication impossibility notification screen (the notification screen 700 or 710) in S607 or S608, the status monitor 209 starts a timer for waiting for a printing cancel button to be pressed down in S610. A button 701 in FIG. 7A and a button 711 in FIG. 7B are this printing cancel button.

Next, in S612, the status monitor 209 determines whether the printing cancel button has been pressed down. If the printing cancel button has not been pressed down, the status monitor 209 proceeds to S611, and if the printing cancel button has been pressed down, the status monitor 209 proceeds to S613.

In S611, the status monitor 209 determines whether a certain period of time has elapsed from the start of the timer and the timer has timed out. If the timer has not timed out, the status monitor 209 returns the processing to S612 and waits for the printing cancel button to be pressed down for a certain period of time.

On the other hand, in S611, if the status monitor 209 has determined that the timer has timed out, the status monitor 209 proceeds to S616. In S616, after closing the printer communication impossibility notification screen, the status monitor 209 returns the processing to S601 to again execute the series of processing from the determination on the state of the first printer. That is, in a case where the user does not perform an operation of canceling the printing for a certain period of time, the status monitor 209 again attempts to obtain information on whether communication is possible with the first printer. In this way, for example, in a case where the state of the first printer has changed from offline to online while waiting for the reception of the printing cancel button in the printer communication impossibility notification screen or other cases, the printing from the first printer becomes possible. That is, at the time of retry, the language monitor 208 proceeds to S603 through the steps of S601 and S602. In S603, the language monitor 208 transmits the job to the first printer. Then, the language monitor 208 ends the print job transmission processing shown in the flowchart of FIG. 6.

On the other hand, if the printing cancel button is pressed down in S612 by the time out, the status monitor 209 proceeds to the processing of S613. In S613, the language monitor 208 performs processing of discarding the job of the first printer. Thereafter, the language monitor 208 ends the print job transmission processing shown in the flowchart of FIG. 6.

Next, the detail of the online printer list creation processing of S604 in FIG. 6 will be described. FIG. 8 is a flowchart showing the detail of the online printer list creation processing of S604. The processing of the present flowchart is executed by the status monitor 209.

First, in S801, the status monitor 209 obtains information on registered printers from the OS-registered printer information 210. Next, in S802, the status monitor 209 starts referring to information from the top of the registered printers.

Subsequently, in S803, the status monitor 209 determines whether the state of the printer being referred to is offline. If the status monitor 209 has determined that the state of the printer is not offline, the status monitor 209 proceeds to S804, and if the status monitor 209 has determined that the state of the printer is offline, the status monitor 209 proceeds to S807.

In S804, the status monitor 209 determines whether the printer name contains a specific character string. In this step, in a case where a property of the printer appears in the printer name, the determination processing is performed on condition that the printer name of the second printer contains the specific character string. This makes it possible to extract a printer with a higher possibility that the processing attempted to be executed in the first printer can be executed instead. In S804, if the status monitor 209 has determined that the printer name contains the specific character string, the status monitor 209 proceeds to S805, and if not, the status monitor 209 proceeds to S807. The specific character string will be described later by using an example. Note that in S804, the specific character string does not necessarily have to be present. In this case, the status monitor 209 proceeds to S805 without performing the determination of S804.

In S805, the status monitor 209 adds, to the online printer list, the printer being referred to.

Subsequently, in S806, the status monitor 209 determines whether the printer being referred to is the last printer in the OS-registered printers. If the printer is the last printer, the status monitor 209 ends the online printer list creation processing, and if not, the status monitor 209 proceeds to S807.

If the status monitor 209 has determined that the state of the printer is offline in S803, or if the status monitor 209 has determined that the printer name does not contain the specific character string in S804, or if the status monitor 209 has determined the printer is not the last printer in S806, in S807, the status monitor 209 refers to the next printer. Then, the status monitor 209 performs the processing of S803 to S806 again.

In this way, loop processing of executing S803 to S806 is performed with respect to all the OS-registered printers, and all the printers which satisfy various determination conditions are added to the online printer list by this loop processing. Then, in S806, if the status monitor 209 determines that the printer being referred to is the last printer, the status monitor 209 ends the online printer list creation processing.

Here, the specific character string will be described by using an example. For example, in a case where the printer name contains a model name, a series name, a model number, or the like, the printer name can be used as the specific character string. A case where information obtained in the OS-registered printer information 210 is information shown in FIG. 4 will be described as an example. In this case, in S803, candidates for online printers are narrowed down to "INKJET YYY series" and "IJ PRINTER". Next, in a case where the specific character string in S804 is assumed to be "INKJET", the printer eventually added to the online printer list is only "INKJET YYY series". Particularly, in a case where the first printer name and the second printer name contain a model name, a series name, a model number, a character string common to both can be used as the specific character string. There is a higher possibility that the second printer thus extracted can execute the processing which has been attempted to execute in the first printer, in place of the first printer.

In a case where print execution is made from an application to a printer with which communication is impossible, if there is another online printer, that is, another printer with which communication is possible, a screen which makes a notification of information on the printer can be displayed by the above-described processing. This makes it possible for the user to find the presence of a printer with which communication is possible even when having made print execution with a printer with which communication is impossible, and to immediately execute printing again with the printer with which communication is possible.

In this way, by applying the present embodiment, the usability in an information processing apparatus to which an external processing apparatus is connected is significantly improved.

### Second Embodiment

In the first embodiment, the example of displaying the notification screen which indicates that communication is impossible with the first printer and information specifying the second printer in a case where the state of the first printer is offline and the state of the second printer is online has been described. Moreover, the example of displaying the notification screen which indicates that there is a possibility that the problem can be solved with the second printer has been described. In contrast, in a second embodiment, an example of displaying a screen which makes it possible to select a second printer from online printers displayed on a notification screen and set the second printer as a default printer will be described. Note that the default printer is a printer which is preferentially handled in the OS, and a printer designated as the default printer is set as an initial value at the time of selecting a processing execution destination from an application, or the like. In the following description, the same or corresponding configurations as or to those in the first embodiment will not be described, and points different from the first embodiment will be mainly described.

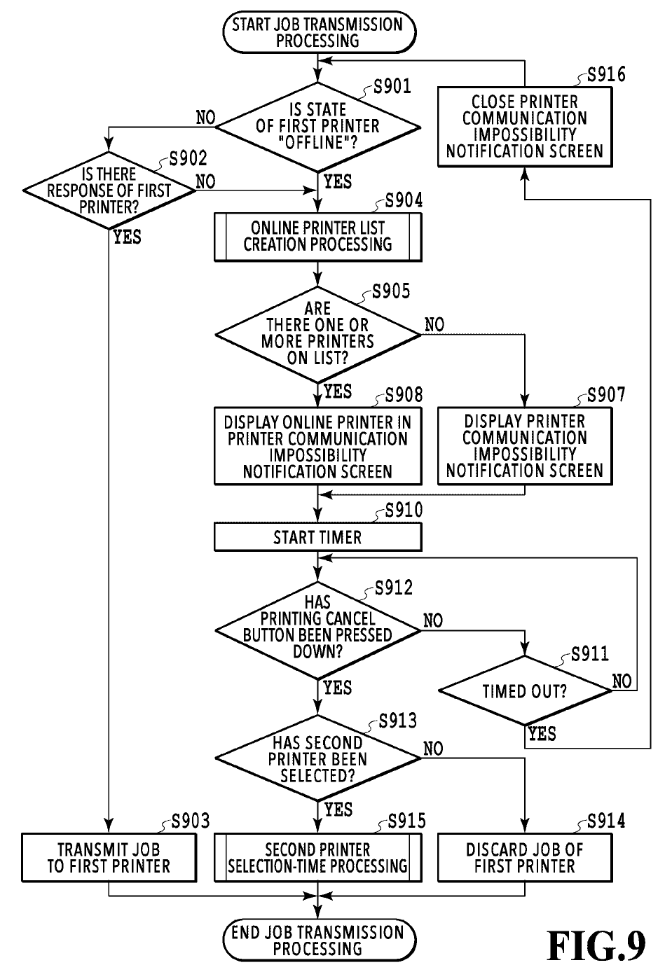

FIG. 9 is a flowchart showing the detail of job transmission processing of S502 in the present embodiment. The processing of the present flowchart is started by an event that the language monitor 208 has detected the print job generated in S501. Note that S901 to S912 in the flowchart shown in FIG. 9 are the same as S601 to S612 of FIG. 6 described in the first embodiment, and S913 to S915 are different from FIG. 6. In addition, a notification screen to be displayed in S908 is different from the notification screen displayed in S608.

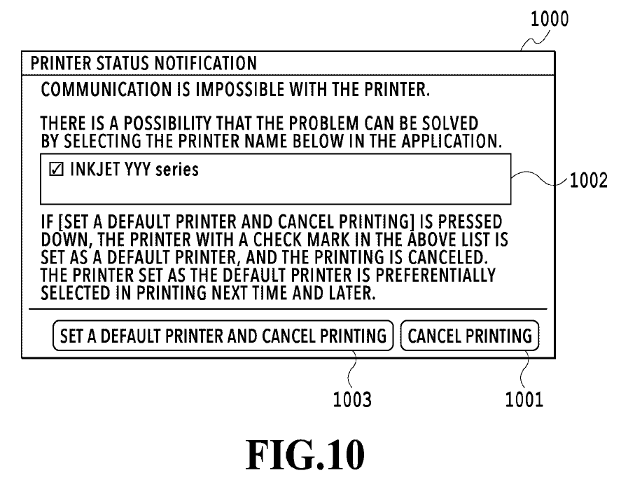

First, the notification screen to be displayed in S908 in the second embodiment will be described. A notification screen 1000 of FIG. 10 is an example of the screen to be displayed in S908. In a control 1002, online printer information is displayed, and the selection of one printer is received from the online printer information based on a user operation. That is, the notification screen 1000 displays a fact that communication is impossible with the first printer, and displays information which prompts designation of another printer in online state as a request destination for a print job as a substitute for the first printer.

A button 1003 of the notification screen 1000 is activated only in a state where one printer has been selected in the control 1002. The button 1003 is a button for setting a printer (second printer) selected in the control 1002 as a default printer and canceling printing based on a user operation.

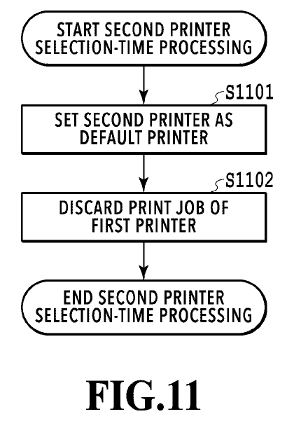

In a case where the button 1003 is pressed down, the printer selected in the control 1002 is selected as the second printer, and then the printing cancel button is regarded as being pressed down. That is, in a case where it is detected that the button 1003 has been pressed down, the status monitor 209 determines that the printing cancel button has been pressed down in S912 of FIG. 9, then determines that the second printer has been selected in S913, and proceeds to second printer selection-time processing of S915. Thereafter, the language monitor 208 ends the print job transmission processing shown in the flowchart of FIG. 9. Note that the detail of the second printer selection-time processing of S915 will be described later in FIG. 11.

On the other hand, in a case where a button 1001 is pressed down in the notification screen 1000, the printing cancel button is regarded as being pressed down while the second printer is not selected. That is, in a case where it is detected that the button 1001 is pressed down, the status monitor 209 determines that the printing cancel button has been pressed down in S912 of FIG. 9, then determines that the second printer has not been selected in S913, and proceeds to S914. Then, in S914, the language monitor 208 discards the job of the first printer. Then, the language monitor 208 ends the print job transmission processing shown in the flowchart of FIG. 9.

Next, the detail of the processing of S915, which is the second printer selection-time processing in a case where the second printer is selected, will be described. FIG. 11 is a flowchart showing the detailed processing of S915, which is the second printer selection-time processing.

First, in S1101, the status monitor 209 instructs the OS to set, as a default printer, an online printer selected as the second printer in the notification screen 1000 of FIG. 10. That is, the status monitor 209 gives a setting instruction to the OS to set the second printer as a default request destination for a print job in a case where an instruction to perform a print job is received next time and later. The printer set as the default printer is preferentially handled as the first printer in the job transmission processing in a case where a print job is received next time and later.

Subsequently, in S1102, the language monitor 208 performs processing of discarding the print job of the first printer. Next, the language monitor 208 ends the series of the second printer selection-time processing.

According to the present embodiment, in a case where print execution is made from an application to a printer with which communication is impossible, a printer communication impossibility notification screen can be displayed, and an online printer selected by the user can be set as a default printer with a simple operation. This allows the user not only to find the presence of another online printer but also to set the online printer as the default printer with a simple operation even in a case where print execution is made with a printer with which communication is impossible. Hence, the user can execute printing in a printer with which communication is possible without confusion when making print execution again.

In this way, by applying the present embodiment, the usability in an information processing apparatus to which an external processing apparatus is connected can be significantly improved.

### Third Embodiment

In the first embodiment, the example of displaying the notification screen which indicates that communication is impossible with the first printer and information specifying the second printer in a case where the state of the first printer is offline and the state of the second printer is online has been described. Moreover, the example of displaying the notification screen which indicates there is a possibility that the problem can be solved with the second printer has been described. In contrast, in a third embodiment, an example of displaying a screen which makes it possible to select a second printer from online printers and make re-print execution in the second printer will be described. In the following description, the same or corresponding configurations as or to those in the first embodiment will not be described, and points different from the first embodiment will be mainly described.

A flowchart showing the detail of job transmission processing of S502 in the third embodiment is FIG. 9, which is the same as in the second embodiment. In the third embodiment as well, S901 to S912 in the flowchart shown in FIG. 9 are the same as S601 to S612 of FIG. 6 described in the first embodiment, and S913 to S915 are different from FIG. 6. In addition, a notification screen to be displayed in S908 is different from the notification screen displayed in S608.

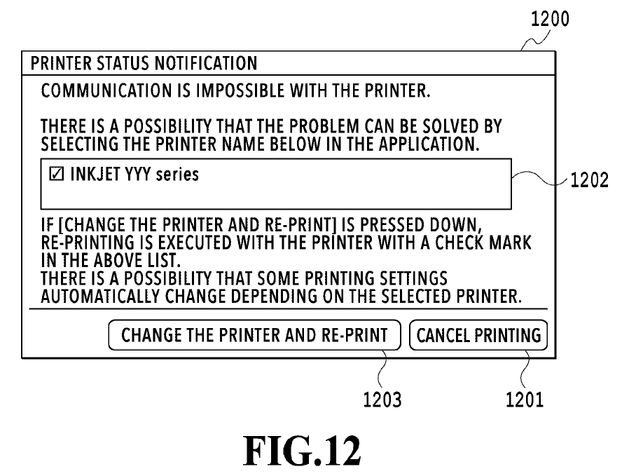

First, a notification screen to be displayed in S908 in the third embodiment will be described. A notification screen 1200 of FIG. 12 is an example of the screen to be displayed in S908 in the third embodiment. In a control 1202, online printer information is displayed, and the selection of one printer is received from the online printer information based on a user operation. That is, the notification screen 1200 displays information which prompts designation of another printer in online state as a request destination for a print job as a substitute for the first printer.

A button 1203 of the notification screen 1200 is activated only in a state where one printer has been selected in the control 1202. The button 1203 is a button for receiving a change from a printer (first printer) in offline state to a printer (second printer) selected in the control 1202 and execution of re-printing based on a user operation.

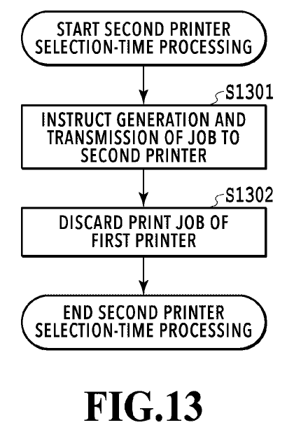

In a case where the button 1203 is pressed down, the printer selected in the control 1202 is selected as the second printer, and then the printing cancel button is regarded as being pressed down. That is, in a case where it is detected that the button 1203 has been pressed down, the status monitor 209 determines that the printing cancel button has been pressed down in S912 of FIG. 9, then determines that the second printer has been selected in S913, and proceeds to second printer selection-time processing of S915. Then, in S914, the language monitor 208 discards the job of the first printer, and ends the print job transmission processing shown in the flowchart of FIG. 9. Note that the detail of the second printer selection-time processing of S915 in the present embodiment will be described later in FIG. 13.

On the other hand, in a case where a button 1201 is pressed down, the printing cancel button is regarded as being pressed down while the second printer is not selected. That is, in a case where it is detected that the button 1201 is pressed down, the status monitor 209 determines that the printing cancel button has been pressed down in S912 of FIG. 9, then determines that the second printer has not been selected in S913, and proceeds to S914. Then, in S914, the language monitor 208 discards the job of the first printer, and ends the print job transmission processing shown in flowchart of FIG. 9.

Next, the detail of the processing of S915 in a case where the second printer is selected will be described. FIG. 13 is a flowchart showing the detailed processing of S915, which is the second printer selection-time processing in the third embodiment.

First, in S1301, the status monitor 209 instructs the printing support function 202 of the OS to generate a job which is the same as the print job of the first printer for the online printer selected as the second printer, and transmit the job to the second printer. The generation of the print job is executed by a series of processing by the respective configurations of the printing support function 202, the UI module 203, the spooler 204, and the graphics driver 207 of the OS as already described in detail in FIG. 2. The generated print job is transmitted from the spooler 204 to the language monitor 208, and the language monitor 208 transmits the print job and a request for executing the print job to the second printer via the input/output I/F 119 and the input/output I/F 130.

Subsequently, in S1302, the language monitor 208 performs processing of discarding the print job of the first printer. Next, the language monitor 208 ends the series of second printer selection-time processing.

According to the present embodiment, in a case where print execution is made from an application to a printer with which communication is impossible, a printer communication impossibility notification screen can be displayed, and print execution can be made to an online printer selected in accordance with an input of the user. This allows the user, even in a case where print execution is made with the printer with which communication is impossible, not only to find the presence of another online printer, but also to cancel the printing of the printer with which communication is impossible and immediately execute re-printing to the selected online printer.

In this way, by applying the present embodiment, the usability in an information processing apparatus to which an external processing apparatus is connected can be significantly improved.

As described above, the control described as being performed by the CPU 112 in the above-mentioned embodiments may be performed by a single piece of hardware, or the control of the entire apparatus may be performed by a plurality of pieces of hardware (for example, a plurality of processors or circuits) dividing the processing.

In addition, although the present invention has been described in detail based on the preferred embodiments, the present invention is not limited to these specific embodiments, and various modes without departing from the gist of the invention are also encompassed by the present invention. Moreover, each of the above-mentioned embodiments is merely showing an embodiment of the present invention, and the embodiments can also be combined as appropriate.

In addition, in the above-mentioned embodiments, cases where the present invention is applied to a PC which can communicate with printers have been described as examples. However, this is not limited to these examples, and the present invention can be applied to any information processing apparatus which can communicate with any external processing apparatus. That is, the present invention can be applied to cases where an operation instruction is outputted from various information processing apparatuses such as a laptop PC, an image processing apparatus, a mobile terminal, a smartphone, and a tablet terminal to external processing apparatuses having communication functions such as smart appliances. For example, the present invention can be applied to cases where an operation instruction is given from a smartphone or a mobile terminal to a lighting instrument, an air conditioner, a robotic vacuum, or the like which has communication functions such as Wi-Fi. Moreover, the present invention can be applied to an external processing apparatus such as a speaker capable of Bluetooth connection, an audio component system capable of Wi-Fi connection, a television having a cast function, and a television to which a cast device is connected. That is, the present invention can be applied to cases where music reproduction is instructed from a smartphone or a mobile terminal to a speaker capable of Bluetooth connection or an audio component system capable of Wi-Fi connection. In addition, the present invention can be applied to cases where video output is instructed from a smartphone or a mobile terminal to a television having a cast function or a television to which a cast device is connected.

### Other embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, the usability in an information processing apparatus to which an external processing apparatus is connected can be improved.

This application claims the benefit of Japanese Patent Application No. 2025-029302, filed February 26, 2025, which is hereby incorporated by reference herein in its entirety.

What is claimed is:

1. A non-transitory computer-readable storage medium storing one or more programs configured to cause one or more computers of an information processing apparatus capable of communicating with an external processing apparatus to function as:
a reception unit configured to receive an instruction to perform specific processing to a first processing apparatus;
a specifying unit configured to specify a processing apparatus which has a name containing a specific character string and is capable of communication in a first case where the instruction is received by the reception unit and communication is impossible with the first processing apparatus; and
a display control unit configured to perform, in the first case, control for displaying first information indicating a second processing apparatus which is different from the first processing apparatus and is specified by the specifying unit.

2. The non-transitory computer-readable storage medium according to claim 1, wherein
the specific character string is a character string contained in a name of the first processing apparatus.

3. The non-transitory computer-readable storage medium according to claim 1, wherein
the name is at least one of a model name, a series name, and a model number of a processing apparatus.

4. The non-transitory computer-readable storage medium according to claim 1, wherein
the specifying unit specifies a processing apparatus which is capable of communicating with the information processing apparatus and contains the specific character string among a processing apparatus registered in an operating system.

5. The non-transitory computer-readable storage medium according to claim 1, wherein
the display control unit performs control for displaying, together with the first information, second information indicating that there is a possibility that the specific processing can be executed in the second processing apparatus.

6. The non-transitory computer-readable storage medium according to claim 1, wherein
the display control unit performs control for displaying, together with the first information, third information which prompts designation of the second processing apparatus as a request destination for the specific processing.

7. The non-transitory computer-readable storage medium according to claim 1, wherein the one or more computers further function as a setting instruction unit configured to instruct, based on a user operation in a state where the first information is displayed, an operating system to set the second processing apparatus as a default request destination for the specific processing in a case where an instruction to perform the specific processing is received next time and later.

8. The non-transitory computer-readable storage medium according to claim 1, wherein the one or more computers further function as a transmission unit configured to transmit a request for executing the specific processing to the second processing apparatus based on a user operation in a state where the first information is displayed.

9. The non-transitory computer-readable storage medium according to claim 1, wherein
the display control unit performs control for displaying fourth information which does not contain information relating to the second processing apparatus and which indicates that communication is impossible with the first processing apparatus in a situation where communication is impossible with the first processing apparatus and also communication is impossible with the second processing apparatus.

10. The non-transitory computer-readable storage medium according to claim 1, wherein
information on whether communication is possible with the first processing apparatus is obtained from an operating system.

11. The non-transitory computer-readable storage medium according to claim 1, wherein
information on whether communication is possible with the first processing apparatus is obtained by obtaining the information from an operating system, and further performing communication for inquiring a state of the first processing apparatus and determining whether a response indicating that the specific processing can be executed is obtained.

12. The non-transitory computer-readable storage medium according to claim 1, wherein
information on whether communication is possible with the second processing apparatus is obtained from an operating system.

13. The non-transitory computer-readable storage medium according to claim 1, wherein
in a case where communication is impossible with the first processing apparatus and the first information which specifies the second processing apparatus is displayed, if a user does not perform an operation to cancel printing for a certain period of time, information on whether communication is possible with the first processing apparatus is obtained again.

14. The non-transitory computer-readable storage medium according to claim 1, wherein
the first information contains at least one of a model name, a series name, and a model number of the second processing apparatus.

15. The non-transitory computer-readable storage medium according to claim 1, wherein
the specific processing is at least one of executions of printing, scanning, and utility functions.

16. The non-transitory computer-readable storage medium according to claim 15, wherein
both of the first processing apparatus and the second processing apparatus are printers.

17. The non-transitory computer-readable storage medium according to claim 16, wherein
the second processing apparatus contains a specific character string in a printer name registered in an operating system.

18. The non-transitory computer-readable storage medium according to claim 1, wherein
the specific processing is an operation instruction to at least one of a lighting instrument having a communication function, an air conditioner having a communication function, a robotic vacuum having a communication function, a speaker having a communication function, an audio component system having a communication function, a television with a cast function, and a television to which a cast device is connected.

19. A method for controlling an information processing apparatus capable of communicating with an external processing apparatus, comprising:
receiving an instruction to perform specific processing to a first processing apparatus;
specifying a processing apparatus which has a name containing a specific character string and is capable of communication in a first case where the instruction to perform the specific processing to the first processing apparatus is received and communication is impossible with the first processing apparatus; and
performing, in the first case, control for displaying first information indicating a second processing apparatus which is different from the first processing apparatus and is the specified processing apparatus capable of communication.

20. An information processing apparatus capable of communicating with an external processing apparatus, comprising:
at least one memory and at least one processor which function as:
a reception unit configured to receive an instruction to perform specific processing to a first processing apparatus;
a specifying unit configured to specify a processing apparatus which has a name containing a specific character string and is capable of communication in a first case where the instruction is received by the reception unit and communication is impossible with the first processing apparatus; and
a display control unit configured to perform, in the first case, control for displaying first information indicating a second processing apparatus which is different from the first processing apparatus and is specified by the specifying unit.
